(19) United States
(12) Patent Application Publication
(10) Pub. No.: US 2007/0210277 A1
(43) Pub. Date: Sep. 13, 2007

(54) Heat transport medium

(75) Inventors: Eiichi Torigoe, Anjo-city (JP); Yoshimasa Hijikata, Nishikamo-gun (JP); Touru Kawaguchi, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/711,179

(22) Filed: Feb. 26, 2007

(30) Foreign Application Priority Data
Mar. 10, 2006 (JP) 2006-066014

(51) Int. Cl. C09K 5/00; C09K 3/18

(52) U.S. Cl. 252/70; 252/71

(57) ABSTRACT

A heat transport medium transports heat transferred from a heat transfer surface 5, the medium comprising a single solvent and containing microparticles 1 of a predetermined substance, wherein the microparticle 1 comprises one or more atoms, structures 3 for protecting the microparticle 1 are arranged on the microparticle surface and, if the diameter of a solvent molecule 2 constituting the medium is a and the length from a functional group 3a of the structure 3, which adsorbs to the microparticle 1, is b, the diameter a and the length b are set to satisfy the relationship a≦b.

### BACKGROUND OF THE INVENTION

1. Field of the Invention

The present invention relates to a heat transport medium, for transferring and transporting heat, comprising a solvent and containing microparticles of a predetermined substance.

2. Description of the Related Art

For example, in a heat exchanger used in a radiator or in an electronic device installed in a vehicle, a heat transport medium for transferring and transporting heat outside a heat source has been conventionally employed. Such a heat transport medium is required to have a high cooling performance, that is, a high heat transport capacity, to increase the energy efficiency of equipment such as a heat exchanger. In order to enhance the heat transport capacity, for example, a technique of incorporating and dispersing solid particles comprising a high thermal-conductivity substance, such as a metal, in the medium is known. By virtue of containing particles of such a high thermal-conductivity substance, the thermal conductivity of the medium, that is, heat transport medium is increased as compared with the thermal conductivity of a medium alone and not containing those particles. More specifically, from Maxwell's relational expression, published in 1881, the thermal conductivity of a heat transport medium containing such particles is known to vary, based on the expression, such that:

the thermal conductivity of a medium containing spherical particles increases according to the volume fraction of the particles, or

the thermal conductivity of a medium containing spherical particles increases according to the ratio of the surface area to the volume of the particles.

However, there is a limit to increasing the thermal conductivity of a medium by such a method.

On the other hand, in recent years, a technique of preparing microparticles at the micron or the nano size, as particles to be incorporated into a medium, is being developed. It has been confirmed that when such microparticles are dispersed in a medium, the thermal conductivity of the medium is remarkably elevated. For example, Applied Physics Letters, Vol. 78, No. 6, pp. 718-720 (2001) reports that when a small amount of microparticles comprising copper (Cu) and having a diameter of 10 nm (nanometer) or less are incorporated into a medium comprising ethylene glycol, the thermal conductivity of the medium is greatly enhanced.

FIG. 1 is a graph showing the relationship between the volume content of particles in a medium and the increase rate k/k₀ of thermal conductivity (thermal conductivity k of medium after addition of microparticles/thermal conductivity k₀ of medium before addition of microparticles) when various kinds of particles, including copper, are added to ethylene glycol. As shown in FIG. 1, when particles having a diameter of about 30 nm and comprising copper oxide (CuO) or alumina (Al₂O₃) or particles having a diameter of about 10 nm or less and comprising copper are contained in a medium, in all cases, the increase rate of thermal conductivity of the medium linearly increases as the volume content of the particle increases. Particularly, in the case of a nanoparticle having a small particle diameter, that is, a diameter of 10 nm or less, even when a small amount of particles are added to a medium, an effect that the thermal conductivity of the medium dramatically increases is provided. Also, when an acid is added to a Cu particle, the particles are dispersed more stably in a medium and therefore, a higher thermal conductivity is obtained. Incidentally, in FIG. 1, Cu(old) indicates a copper particle prepared 2 months before measurement, Cu(flesh) indicates a copper particle prepared 2 days before measurement, and Cu+Acid indicates a copper particle stabilized as a metal particle by adding an acid.

Similarly to the above-cited Applied Physics Letters, Vol. 78, No. 6, pp. 718-720 (2001), it is also reported, for example, in Japanese Unexamined Patent Publication (Kokai) Nos. 2004-85108, 2004-501269 and 2004-339461 that when high thermal-conductivity microparticles are dispersed in a medium, the thermal conductivity and thermal diffusivity of the medium can be enhanced. Japanese Unexamined Patent Publication (Kokai) No. 2004-501269 further reports that when a carboxylate is adsorbed to the surface of a metal microparticle, a colloid solution of microparticles can be stabilized and heat transfer can be made to smoothly proceed between the microparticle and the medium. Incidentally, in the case where particles are contained in a medium in this way, the particles are preferably dispersed more stably in the medium. As regards the technique for stably dispersing particles in a medium, although the medium is not a heat transport medium, for example, Japanese Unexamined Patent Publication (Kokai) Nos. 2002-532243 and 2002-532242 have proposed a technique of, for example, in an inkjet printer, using a polymer having a hydrophilic group and a hydrophobic group as the dispersant at the time of dispersing hydrophobic particles in a medium such as water. In these techniques described in Japanese Unexamined Patent Publication (Kokai) Nos. 2002-532243 and 2002-532242, more stable dispersion of particles in a medium is attained by utilizing solvation resulting from compatibilization of a solvent with the particle surface.

In all of these conventional heat transport mediums, the heat transport capacity of the medium is enhanced by increasing the thermal conductivity of the medium. However, the thermal conductivity is originally an index showing the ease of heat transfer inside a material (here a medium) and in practical use, as a heat transfer medium, the heat transfer coefficient which is an index showing the movement of heat from a heat transfer surface as a heat source to a medium or from the medium to the heat transfer surface is also an important factor in addition to the thermal conductivity.

Incidentally, the heat transfer coefficient a and the thermal conductivity k of a medium have the following relationship:

a∝k^{2/3}·v^{(-1/6)}·a^{1/3}·Cp^{1/3} (1)

wherein v represents a viscosity of the medium, a represents a density of the medium, and Cp represents a specific heat of the medium. As is apparent from formula (1), the heat transfer coefficient a of the medium is proportional to the “⅔ power” of the thermal conductivity k. Therefore, even when the thermal conductivity of a heat transfer medium can be remarkably enhanced by the above-described conventional techniques of dispersing microparticles in the medium, the effect of enhancing the heat transfer coefficient of this medium is “⅔ power” times the enhanced thermal conductivity. Thus, it is difficult to enhance both the thermal conductivity and the heat transfer coefficient at the same time.

### SUMMARY OF THE INVENTION

Under the above circumstances, the present invention has been made and an object of the present invention is to provide a heat transport medium which can adequately enhance the heat transfer coefficient while maintaining high thermal conductivity and realize more efficient heat transport.

In order to achieve this object, the invention described in Embodiment 1, described hereinafter, is constituted to provide a heat transfer medium for transporting heat transferred from a heat transfer surface, the medium comprising a single solvent and containing microparticles of a predetermined substance, wherein the microparticle comprises one or more atoms, structures for protecting the microparticle are arranged on the microparticle surface and, if the diameter of a solvent molecule constituting the medium is a and the length from the base at which the structure is adsorbed to the microparticle is b, the diameter and the length are set to satisfy the relationship a≦b. Also, the invention described in Embodiment 14, also described hereinafter, is constructed to provide a heat transport medium for transporting heat transferred from a heat transfer surface, the medium comprising two or more kinds of solvents and containing microparticles of a predetermined substance, wherein the microparticle comprises one or more atoms, structures for protecting the microparticle are arranged on the microparticle surface and, if the diameter of a solvent molecule having a maximum diameter out of the solvent molecules constituting the medium is a and the length from the base at which the structure is adsorbed to the microparticle is b, the diameter and the length are set to satisfy the relationship a≦b. Note, in this section, that the embodiments referred to herein are summarized in the last section of the specification.

According to such a construction of the heat transport medium, a solvent molecule can readily enter between structures arranged on the surface of the microparticle or attach to the surface of the structure, so that a structured region can be created in the form of the solvent molecules adsorbing to the periphery of a microparticle. Also, when the medium comprises a single solvent, the above-described length b of the structure is set to be not less than the diameter a of the solvent molecule, and when the medium comprises two or more kinds of solvents, the above-described length b of the structure is set to be not less than the diameter a of a solvent molecule having a maximum diameter out of the solvent molecules, so that the structure can be easily deformed due to vibration, fluctuation or the like and this can facilitate causing desorption of the solvent molecule from the microparticle and structure surfaces, that is, dissolution of the structured region. Such creation and dissolution of the structured region involves an exothermic reaction and an endothermic reaction, respectively, between the solvent molecule and the microparticle or structure through the structural change. Accordingly, a heat quantity corresponding to the latent heat is transferred to the medium from the heat transfer surface, whereby the heat transfer coefficient as a heat transfer medium is enhanced and in turn the heat transport capacity of the medium is increased.

Furthermore, in the construction of Embodiment 1 or Embodiment 14 when the thermal conductivity of the microparticle is set to be larger than the thermal conductivity of the solvent as in the invention of Embodiment 2 or Embodiment 15, that is, when a microparticle having a thermal conductivity larger than the thermal conductivity of the solvent is used, microparticles higher in the thermal conductivity than the solvent are dispersed in a medium and the thermal conductivity of the medium is unfailingly enhanced.

In regard to the construction of Embodiment 1 or 2 or the construction of Embodiment 14 or 15, for example,

(A1) a configuration that the structure comprises a linear organic material regularly arranged on the surface of the microparticle, as in the invention of Embodiments 3 or 16; or

(A2) a configuration that the structure comprises a cyclic organic material regularly arranged on the surface of the microparticle, as in the invention of Embodiments 4 or 17

may be employed.

In any of these configurations, the structures are regularly arranged on the microparticle surface and the structuring is thereby promoted.

Furthermore, in the construction of Embodiments 1 to 4 or the construction of Embodiments 14 to 17, when the average diameter of the microparticle is 5 nm or less, as in the invention of Embodiment 5 or 18, the surface area of the microparticle dispersed in the medium is remarkably increased, so that a larger number of solvent molecules can be made to participate in the creation of the structured region and the heat transport capacity, as a heat transport medium, can be more enhanced.

In regard to the construction of Embodiments 1 to 5 or the construction of Embodiments 14 to 18, for example,

(B1) a constitution that the microparticle comprises a metal, as in the invention of Embodiment 6 to 19;

(B2) a constitution that the microparticle comprises an inorganic material, as in the invention of Embodiment 7 or 20;

(B3) a constitution that the microparticle comprises an oxide, as in the invention of Embodiment 8 or 21;

(B4) a constitution that the microparticle comprises an organic material, as in the invention of Embodiment 9 or 22; or

(B5) a constitution that the microparticle comprises two or more kinds of substances, as in the invention of Embodiment 10 or 23

may be employed.

In addition, in regard to the constitution of (B5), it is particularly effective when, for example, as in the invention of Embodiment 11 or 24, the microparticle comprising two or more kinds of substances has a layered construction and the substance present in the more inner layer has a higher thermal conductivity than that of the substance present in the more outer layer. Whichever substance or constitution out of those described above is employed as the microparticle, a heat transport medium having high heat transport capacity can be obtained. In particular, when the thermal conductivity of a microparticle having a layered construction of a plurality of substances is higher on the more inner layer side as in the construction of claim 11, heat transfer from the heat transfer surface readily occurs not only to the surface of the microparticle but also to the inside of the microparticle.

In regard to the construction of Embodiment 6, for example,

(C1) a constitution that the microparticle comprising a metal comprises gold, the solvent comprises toluene and the structure has a hydrophilic group, as in the invention of Embodiment 12; or

(C2) a constitution that the microparticle comprising a metal comprises gold, the solvent comprises toluene and the structure has a hydrophobic group, as in the invention of Embodiment 13

may be employed. Out of these, according to the constitution of (C1), for example, a mercaptosuccinic acid may be used as the structure, and according to the constitution of (C2), for example, n-octadecanethiol may be used as the structure.

In regard to the construction in any one of Embodiments 1 to 24, from the standpoint of forming the medium as an antifreeze solution, it is effective that the medium contains one or more kinds of freezing-point depressants as in the invention of Embodiment 25. As for the freezing-point depressant, for example,

(D1) a solid freezing-point depressant such as potassium acetate, as in the invention of Embodiment 26; or

(D2) a liquid freezing-point depressant such as ethylene glycol, as in the invention of Embodiment 27

may be used. In either case, according to such a construction of the heat transport medium, even when the medium is, for example, cooling water or oil in a vehicle, its practical use particularly in a cold region or the like is facilitated by virtue of depression of the freezing point. Furthermore, as in the invention of Embodiment 28, the medium in any one of Embodiments 25 to 27 may be constructed to contain at least either one of a rust inhibitor and an antioxidant as an additive.

### BRIEF DESCRIPTION OF THE DRAWINGS

FIG. 1 is a graph showing the relationship between the volume content of microparticle and the thermal conductivity of medium according to one conventional example of the heat transport medium;

FIGS. 2A and 2B are a view schematically showing the structured state and a view schematically showing the dissolved state, according to the first embodiment of the heat transport medium of the present invention, respectively;

FIG. 3 is a graph plotting a simplified and enlarged view of FIG. 2A;

FIGS. 4A to 4D are views schematically showing other construction examples of the structure according to modification examples of the heat transport medium of the first embodiment; and

FIG. 5 is a perspective view schematically showing a perspective construction of the microparticle according to a modification example of the heat transport medium of the first embodiment.

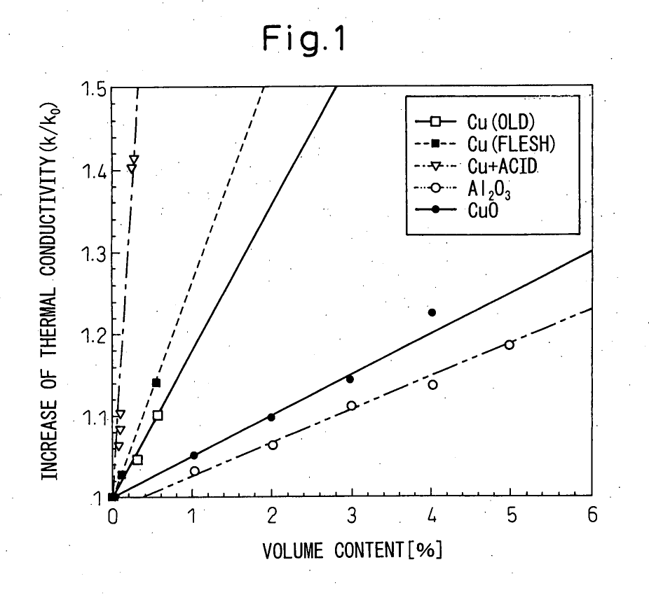

### DESCRIPTION OF THE PREFERRED EMBODIMENTS

The present invention will be further described with reference to the first, second and other preferred embodiments thereof. Note, however, that the present invention should not be restricted to these embodiments.

### First Embodiment

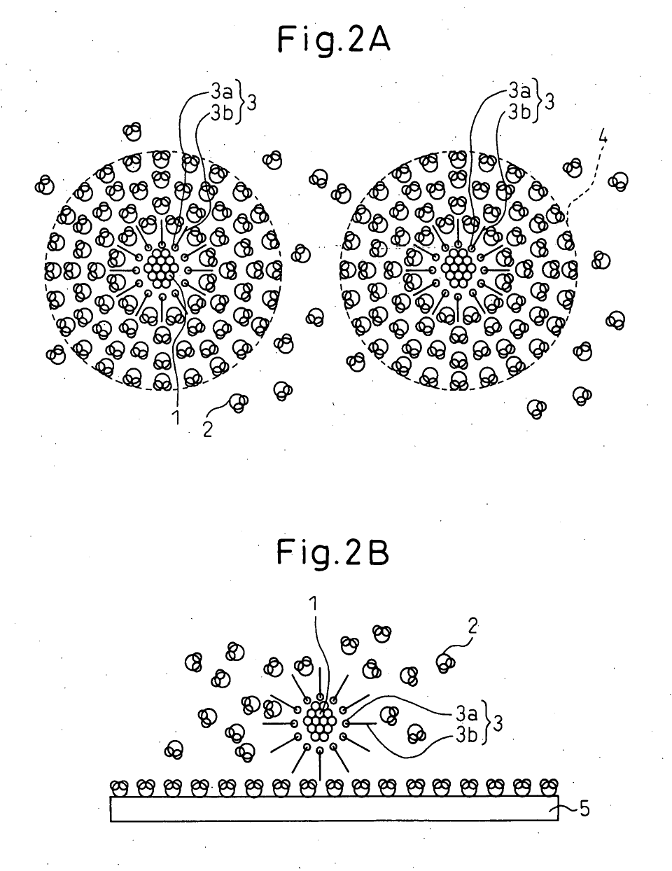

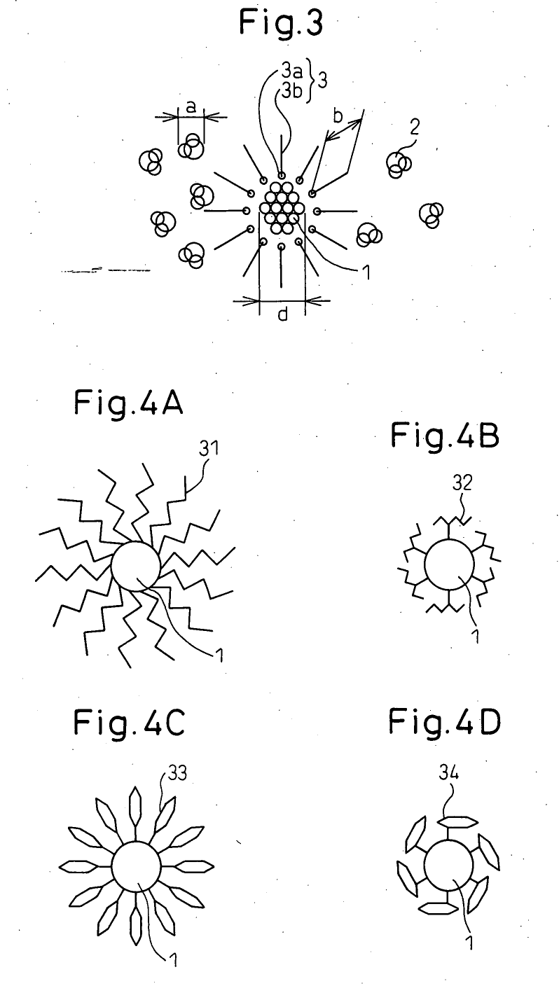

The first embodiment of the heat transport medium of the present invention is described below by referring to FIGS. 2A, 2B and 3.

The heat transport medium according to this embodiment is used to cool, for example, an engine oil or transmission oil in vehicles or for a lubrication purpose, and is a medium for transferring and transporting heat outside from a heat source. The medium used as this heat transfer medium comprises a single solvent such as water and contains microparticles having a higher thermal conductivity than that of the solvent.

The heat transport medium according to this embodiment transfers heat by having two different states, that is, a so-called structured state created in the form of a solvent surrounding the microparticle, and a dissolved state resulting from dissolution of the structured state. FIGS. 2A and 2B are views schematically showing these two states in the heat transfer medium, respectively.

As shown in FIG. 2A, in the structured state, a plurality of microparticles 1 each surrounded by solvent molecules 2 comprising water are dispersed in the heat transport medium. Examples of the microparticle 1 which can be used include a metal such as gold (Au), silver (Ag), copper (Cu), iron (Fe) and nickel (Ni), a particle comprising an inorganic material such as silicon (Si) and fluorine (F), a particle comprising an oxide such as alumina (Al₂O₃), magnesium oxide (MgO), copper oxide (CuO), diiron trioxide (Fe₂O₃) and titanium oxide (TiO), and a polymer particle comprising a resin or the like. On the surface of each microparticle 1 dispersed in the medium, structures 3 for protecting the microparticle 1 are regularly arranged, whereby a protective film is formed. The structure 3 comprises a functional group 3a which is a group adsorbing to the surface of the microparticle 1, and a functional group 3b having high affinity for the solvent molecule 2, and at the same time, the main chain thereof comprises an organic material. For example, in the case of using gold as the microparticle 1, a group such as thiol group (SH group) may be used as the functional group 3a adsorbing to the microparticle 1, and a hydrophilic group such as carboxyl group (COOH group), amino group (NH₂ group), hydroxyl group (OH group) and sulfo group (SO₃H) may be used as the functional group 3b having high affinity for the solvent molecule 2 comprising water. Specifically, a mercaptosuccinic acid (C₄H₆O₄S) with the functional group 3a comprising a thiol group and the functional group 3b comprising a hydroxyl group may be used as the structure 3. By virtue of arrangement of such structures 3 on the surface of the microparticle 1, the solvent molecule 2 is allowed to enter between the structures 3 or attach to the surface thereof, and a structured region 4 where solvent molecules 2 are gathered around the microparticle 1 is created, whereby each microparticle 1 is stably dispersed in the medium.

This structured state turns into a dissolved state shown in FIG. 2B due to various factors such as collision of microparticles with each other, collision against wall surface of a heat exchanger or the like through which the heat transport medium flows, or vibration of the structure 3 resulting from change in the temperature of the heat transport medium. In the dissolved state, the solvent molecule 2 desorbs from between the structures 3 or from the surface thereof and comes to be irregularly present in the medium and at the same time, a part of the desorbed solvent molecules 2 adsorb to a heat transfer surface 5 to which heat from the heat transport medium is transferred.

These two different states shown in FIGS. 2A and 2B are reversibly changed along with absorption of heat to the medium from the outside or release of heat to the outside from the medium. The change of “structured state→dissolved state” is an endothermic reaction, while the change of “dissolved state→structured state” is an exothermic reaction, and the change between these two states causes generation of latent heat. The latent heat indicates an energy difference between two states at a certain fixed temperature. Describing this by taking water as an example, the latent heat generated due to structural change from water in a solid state (ice) to water in a liquid state is about 6,000 J/mol (joule/mol). This value is very large as compared with the molar specific heat (sensible heat) of water, that is, 75 J/mol. The present inventors have confirmed that the latent heat (energy difference) between the structured state and the dissolved state according to this embodiment is also large, and it is intended to transport a remarkably large quantity of heat through the change between these states.

FIG. 3 shows a schematic view more simplified by enlarging FIG. 2A, and the more specific construction of the structured state is described in detail below by referring to FIG. 3. Incidentally, the construction is described here by taking as an example a case where the solvent molecule 2 is water, the microparticle 1 is gold and the structure 3 is a mercaptosuccinic acid. As shown in FIG. 3, the solvent molecule 2 used for the heat transport medium according to this embodiment has a diameter a of about 0.1 nm. Also, when the structures 3 arranged on the surface of the microparticle 1 each comprises, for example, a mercaptosuccinic acid, the length b from the functional group 3a adsorbing to the microparticle 1 is about 1 nm. In other words, the length b of the structure 3 is not less than the diameter a of the solvent molecule 2 and these have a relationship a≦b. By virtue of such a construction, the solvent molecule 2 is allowed to readily enter between the structures 3 and attach to the surface thereof, and this facilitates the creation of the above-described structured region 4 (see, FIG. 2A) where solvent molecules 2 are adsorbing to the surface of the microparticle 1.

More specifically, the microparticle 1 comprises an aggregate of, for example, 150 gold (Au) atoms, and the average diameter d thereof is about 1.8 nm. In this way, a particle having an average diameter of 2 nm or less and empirically not more than 5 nm at a maximum, is used as the microparticle 1, whereby the surface area of the microparticle 1 dispersed in the medium is remarkably increased and a larger number of solvent molecules 2 can be made to participate in the creation of the structured region 4.

As described in the foregoing pages, according to the heat transport medium of this embodiment, the following effects are obtained.

(1) The microparticle 1 comprises about 150 gold (Au) atoms, structures 3 for protecting the microparticle 1 are arranged on the surface thereof, and the length b of the structure 3 is not less than the diameter a of the solvent molecule 2, so that the solvent molecule 2 can be allowed to readily enter between the structures 3 arranged on the microparticle 1 surface or attach to the surface of the structure 3 and a structured region 4 can be created in the form of those solvent molecules 2 adsorbing around the microparticle 1. Furthermore, the structure 3 can be easily deformed due to vibration, fluctuation or the like and this can facilitate causing desorption of the solvent molecule 2 from the microparticle 1 and structure 3 surfaces, that is, dissolution of the structured region 4. Such creation and dissolution of the structured region 4 involve an exothermic reaction and an endothermic reaction, respectively, between the solvent molecule 2 and the microparticle 1 or structure 3 through the structural change. Accordingly, a heat quantity corresponding to the latent heat is transferred to the medium from the heat transfer surface, whereby the heat transfer coefficient as a heat transfer medium is enhanced and in turn the heat transport capacity of the medium is increased.

(2) A substance having a thermal conductivity larger than the thermal conductivity of the solvent is used as the microparticle 1, whereby microparticles 1 higher in the thermal conductivity than the solvent are dispersed in the medium and the thermal conductivity of the medium is unfailingly enhanced.

(3) The structure 3 comprises a linear organic material regularly arranged on the surface of the microparticle 1, whereby the structuring of the microparticle 1 and the solvent molecule 2 is promoted.

(4) The microparticle 1 comprises a particle having an average diameter d of not more than 5 nm at a maximum and the surface area of the microparticle 1 dispersed in the medium is thereby remarkably increased, so that a larger number of solvent molecules 2 can be made to participate in the creation of the structured region 4 and the heat transport capacity as a heat transport medium can be more enhanced.

Further, the heat transport medium according to the first embodiment may be modified as follows.

### MODIFICATION EXAMPLE 1

In the first embodiment, the microparticle 1 used for the heat transport medium is gold (Au), the solvent is water and the structure 3 arranged on the surface of the microparticle 1 has a hydrophilic functional group (hydrophilic group) 3b, but an organic solvent may be used as the solvent instead. Specific examples thereof include toluene, hexane, diethylether, chloroform, ethyl acetate, tetrahydrofuran, methylene chloride, acetone, acetonitrile, N,N-dimethylformamide, dimethylsulfoxide, butanol acetate, 2-propanol, 1-propanol, ethanol, methanol and formic acid. In this case, a structure 3 having a group (functional group) 3a adsorbing to the microparticle 1 surface and at the same time, having a hydrophobic group such as alkyl group (CₙH₂ₙ₊₁) having high affinity for the solvent molecule 2 of the organic solvent may be used. By virtue of such a construction, the solvent molecule 2 is allowed to enter between the structures 3 or attach to the surface of the structure 3, and a structured region 4 is created. Specifically, for example, when toluene is used as the solvent, the diameter a of the solvent molecule 2 is about 0.6 nm, and for example, when octadecanethiol (C₁₈H₃₇SH) is used as the structure 3 arranged on the microparticle 1 surface, the length b from the base 3a at which the structure adsorbs to the microparticle 1 is about 2.5 nm. That is, also in this Modification Example 1, the length b of the structure 3 is not less than the diameter a of the solvent molecule 2, and these have a relationship a≦b.

### MODIFICATION EXAMPLE 2

In the first embodiment, as shown in FIGS. 2A, 2B and 3, the structure 3 arranged on the surface of the microparticle 1 has a group (functional group) 3a adsorbing to the microparticle 1 surface and a functional group 3b having high affinity for the solvent molecule 2, and the main chain thereof comprises a linear organic material, but the construction of the structure 3 may be changed to the following configuration. FIGS. 4A to 4D are views schematically showing only the microparticle 1 and the structures 31 to 34 of the heat transport mediums shown in FIGS. 2A, 2B and 3. That is, the construction may have a linear configuration where, as shown in FIG. 4A, the main chain of the structure 31 is arranged along the direction departing from the microparticle 1 surface; a linear configuration where, as shown in FIG. 4B, the main chain of the structure 32 is arranged along the microparticle 1 surface; a cyclic configuration where, as shown in FIG. 4C, the main chain of the structure 33 is arranged along the direction departing from the microparticle 1 surface; or a cyclic configuration where, as shown in FIG. 4D, the main chain of the structure 34 is arranged along the microparticle 1 surface. In brief, a configuration can be employed for the heat transport medium as long as the structures 31, 32, 33 or 34 are regularly arranged on the microparticle 1 surface.

### MODIFICATION EXAMPLE 3

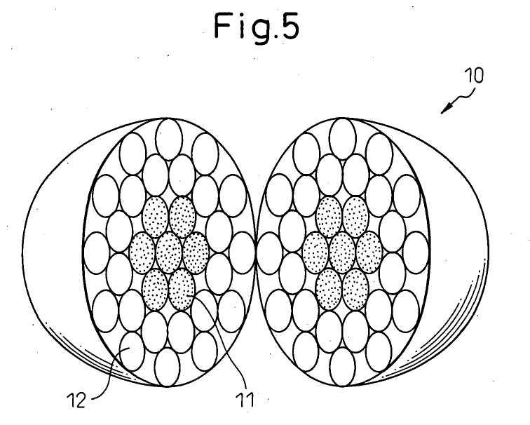

In the first embodiment, the microparticle 1 comprises gold (Au), but, as shown in FIG. 5, a microparticle comprising two or more kinds of substances and having a layered structure may be used instead. That is, as shown in FIG. 5, the microparticle 1 has a two-layer construction of an inner layer part 11 and an outer layer part 12. In this case, a microparticle where the inner layer part 11 comprises, for example, a metal having good thermal conductivity and the outer layer part 12 comprises, for example, a metal lower in the thermal conductivity than the inner layer part 11, an oxide or a resin, may be used. By virtue of such a construction that the thermal conductivity of the inner layer substance of the microparticle 1 is high, heat transfer from the heat transfer surface 5 (see, FIG. 2B) not only to the microparticle 1 surface but also to the inside of the microparticle 1 can readily occur. Incidentally, in the case where the microparticle 1 comprises three or more kinds of substances, a microparticle having a multilayer construction according to the number of substance species may also be used. Also in this case, the same effect can be obtained by employing a constitution that the substance of the more inner layer has higher thermal conductivity.

### SECOND EMBODIMENT

The second embodiment of the heat transport medium is described below. The heat transport medium according to this embodiment is the same as the above-described embodiment in view of the fundamental construction but is different from the above embodiment in the point that the medium comprises two or more kinds of solvents. That is, in this embodiment, the medium uses water and ethylene glycol. The ethylene glycol can act as a freezing-point depressant which comprises a liquid having freezing-point depressing activity, and can depress the freezing point of the medium to about −20° C. In other words, this medium is more excellent for practical use in a cold region or the like. Also in this embodiment, gold (Au) may be used as the microparticle 1, a mercaptosuccinic acid, for example, may be used as the structure, and the length b of the structure 3 and the diameter a of a solvent molecule 2 having a maximum diameter out of those two kinds of solvents have a relationship a≦b. By virtue of such a construction, the solvent molecules of both of those solvents are allowed to readily enter between the structures 3 arranged on the microparticle 1 surface or attach to the structure surface, and these solvent molecules 2 adsorb to the microparticle 1 surface, whereby a structured region 4 (see FIG. 2A) is readily created. As for the freezing-point depressant, other than that described above, for example, propylene glycol may also be used.

As described in the foregoing pages, and also by the heat transport medium according to the second embodiment, the same effects as those of (1) to (4) in the first embodiment or the effects pursuant thereto are obtained.

Also in regard to this heat transport medium of the second embodiment, the kind of the solvent or structure 3 or the construction of the structure 3 may be changed according to the modification examples added to the first embodiment.

In the above-described second embodiment, the medium comprises two or more kinds of solvents and a liquid having freezing-point depressing activity is used as one of those solvents, but it may be also possible that the medium comprises one kind of solvent and a solid freezing-point depressant is contained therein. For example, water may be used as the solvent and potassium acetate, sodium acetate or the like may be used as the freezing-point depressant. Also in the case where the medium comprises two or more kinds of solvents, a solid freezing-point depressant may be similarly contained. Even by such a construction, the freezing point of the heat transport medium can be depressed and the practical utility in a cold region or the like can be thereby enhanced. Furthermore, if desired, a rust inhibitor or an antioxidant may be incorporated as an additive into the medium, in addition to the freezing-point depressant. Incidentally, when there is no need to depress the freezing point of the medium, two or more kinds of solvents not containing a freezing-point depressant may be used as the medium.

### OTHER EMBODIMENTS

Other than those described above, elements which can be modified in common with the above-described embodiments and modification examples include the following.

In the embodiments above and modification examples thereof, a particle having an average diameter d of about 1.8 nm is employed as the microparticle 1, but as described above, as long as the average diameter d of the microparticle 1 is not more than about 5 nm at a maximum, a sufficiently high effect of increasing the surface area of the microparticle 1 dispersed in the medium can be obtained. Of course, when the thermal conductivity and heat transfer coefficient can be satisfactorily enhanced through creation or dissolution of a structured region 4 by structures 3 arranged on the microparticle 1 surface and solvent molecules 2, a particle having an average diameter d in excess of 5 nm may be employed as the microparticle 1.

In the embodiments above and modification examples thereof, a substance having a thermal conductivity larger than the thermal conductivity of the solvent is used as the microparticle 1. However, when the thermal conductivity and heat transfer coefficient can be satisfactorily enhanced through creation or dissolution of a structured region 4 by structures 3 arranged on the microparticle 1 surface and solvent molecules 2, the relationship of thermal conductivity between microparticle and solvent employed is not limited to the above-described relationship.

Finally, the following is a summary of the Embodiments in the above-mentioned section entitled “Summary of the Invention”.

[Embodiment 1] A heat transport medium for transporting heat transferred from a heat transfer surface, the medium comprising a single solvent and containing microparticles of a predetermined substance, wherein

the microparticle comprises one or more atoms, structures for protecting the microparticle are arranged on the microparticle surface and, if the diameter of a solvent molecule constituting the medium is a and the length from the base at which the structure is adsorbed to the microparticle is b, the diameter and the length are set to satisfy the relationship a≦b.

[Embodiment 2] The heat transport medium as described in Embodiment 1, wherein the thermal conductivity of the microparticle is larger than the thermal conductivity of said solvent.

[Embodiment 3] The heat transport medium as described in Embodiment 1 or 2, wherein the structure comprises a linear organic material regularly arranged on the surface of the microparticle.

[Embodiment 4] The heat transport medium as described in Embodiment 1 or 2, wherein the structure comprises a cyclic organic material regularly arranged on the surface of the microparticle.

[Embodiment 5] The heat transport medium as described in any one of Embodiments 1 to 4, wherein the average diameter of the microparticles is 5 nm (nanometer) or less.

[Embodiment 6] The heat transport medium as described in any one of Embodiments 1 to 5, wherein the microparticle comprises a metal.

[Embodiment 7] The heat transport medium as described in any one of Embodiments 1 to 5, wherein the microparticle comprises an inorganic material.

[Embodiment 8] The heat transport medium as described in any one of Embodiments 1 to 5, wherein the microparticle comprises an oxide.

[Embodiment 9] The heat transport medium as described in any one of Embodiments 1 to 5, wherein the microparticle comprises an organic material.

[Embodiment 10] The heat transport medium as described in any one of Embodiments 1 to 5, wherein the microparticle comprises two or more kinds of substances.

[Embodiment 11] The heat transport medium as described in Embodiment 10, wherein the microparticle comprising two or more kinds of substances has a layered construction and the substance present in the more inner layer has a higher thermal conductivity than that of the substance present in the more outer layer.

[Embodiment 12] The heat transport medium as described in Embodiment 6, wherein the microparticle comprising a metal comprises gold, the solvent comprises water and the structure has a hydrophilic group.

[Embodiment 13] The heat transport medium as described in Embodiment 6, wherein the microparticle comprising a metal comprises gold, the solvent comprises toluene and the structure has a hydrophobic group.

[Embodiment 14] A heat transport medium for transporting heat transferred from a heat transfer surface, the medium comprising two or more kinds of solvents and containing microparticles of a predetermined substance, wherein

the microparticle comprises one or more atoms, structures for protecting the microparticle are arranged on the microparticle surface and, if the diameter of a solvent molecule having a maximum diameter out of the solvent molecules constituting the medium is a and the length from the base at which the structure is adsorbed to the microparticle is b, the diameter and the length are set to satisfy the relationship a≦b.

[Embodiment 15] The heat transport medium as described in Embodiment 14, wherein the thermal conductivity of the microparticle is larger than the thermal conductivity of the solvent.

[Embodiment 16] The heat transport medium as described in Embodiment 14 or 15, wherein the structure comprises a linear organic material regularly arranged on the surface of the microparticle.

[Embodiment 17] The heat transport medium as described in Embodiment 14 or 15, wherein the structure comprises a cyclic organic material regularly arranged on the surface of the microparticle.

[Embodiment 18] The heat transport medium as described in any one of Embodiments 14 to 17, wherein the average diameter of the microparticles is 5 nm (nanometer) or less.

[Embodiment 19] The heat transport medium as described in any one of Embodiments 14 to 18, wherein the microparticle comprises a metal.

[Embodiment 20] The heat transport medium as described in any one of Embodiments 14 to 18, wherein the microparticle comprises an inorganic material.

[Embodiment 21] The heat transport medium as described in any one of Embodiments 14 to 18, wherein the microparticle comprises an oxide.

[Embodiment 22] The heat transport medium as described in any one of Embodiments 14 to 18, wherein the microparticle comprises an organic material.

[Embodiment 23] The heat transport medium as described in any one of Embodiments 14 to 18, wherein the microparticle comprises two or more kinds of substances.

[Embodiment 24] The heat transport medium as described in Embodiment 23, wherein the microparticle comprising two or more kinds of substances has a layered construction and the substance present in the more inner layer has a higher thermal conductivity than that of the substance present in the more outer layer.

[Embodiment 25] The heat transport medium as described in any one of Embodiments 1 to 24, wherein the medium contains one or more kinds of freezing-point depressants.

[Embodiment 26] The heat transport medium as described in Embodiment 25, wherein the freezing-point depressant is a solid freezing-point depressant.

[Embodiment 27] The heat transport medium as described in Embodiment 25, wherein the freezing-point depressant is a liquid freezing-point depressant.

[Embodiment 28] The heat transport medium as described in any one of Embodiments 25 to 27, wherein the medium contains at least either one of a rust inhibitor and an antioxidant as an additive.

1. A heat transport medium for transporting heat transferred from a heat transfer surface, the medium comprising a single solvent and containing microparticles of a predetermined substance, wherein
said microparticle comprises one or more atoms, structures for protecting said microparticle are arranged on the microparticle surface and, if the diameter of a solvent molecule constituting said medium is a and the length from the base at which said structure is adsorbed to said microparticle is b, the diameter and the length are set to satisfy the relationship a≦b.

2. The heat transport medium as defined in claim 1, wherein the thermal conductivity of said microparticle is larger than the thermal conductivity of said solvent.

3. The heat transport medium as defined in claim 1, wherein said structure comprises a linear organic material regularly arranged on the surface of said microparticle.

4. The heat transport medium as defined in claim 1, wherein said structure comprises a cyclic organic material regularly arranged on the surface of said microparticle.

5. The heat transport medium as defined in claim 1, wherein the average diameter of said microparticles is 5 nm (nanometer) or less.

6. The heat transport medium as defined in claim 1, wherein said microparticle comprises a metal.

7. The heat transport medium as defined in claim 1, wherein said microparticle comprises an inorganic material.

8. The heat transport medium as defined in claim 1, wherein said microparticle comprises an oxide.

9. The heat transport medium as defined in claim 1, wherein said microparticle comprises an organic material.

10. The heat transport medium as defined in claim 1, wherein said microparticle comprises two or more kinds of substances.

11. The heat transport medium as defined in claim 10, wherein said microparticle comprising two or more kinds of substances has a layered construction and the substance present in the more inner layer has a higher thermal conductivity than that of the substance present in the more outer layer.

12. The heat transport medium as defined in claim 6, wherein said microparticle comprising a metal comprises gold, said solvent comprises water and said structure has a hydrophilic group.

13. The heat transport medium as defined in claim 6, wherein said microparticle comprising a metal comprises gold, said solvent comprises toluene and said structure has a hydrophobic group.

14. A heat transport medium for transporting heat transferred from a heat transfer surface, the medium comprising two or more kinds of solvents and containing microparticles of a predetermined substance, wherein
said microparticle comprises one or more atoms, structures for protecting said microparticle are arranged on the microparticle surface and, if the diameter of a solvent molecule having a maximum diameter out of the solvent molecules constituting said medium is a and the length from the base at which said structure is adsorbed to said microparticle is b, the diameter and the length are set to satisfy the relationship a≦b.

15. The heat transport medium as defined in claim 14, wherein the thermal conductivity of said microparticle is larger than the thermal conductivity of said solvent.

16. The heat transport medium as defined in claim 14, wherein said structure comprises a linear organic material regularly arranged on the surface of said microparticle.

17. The heat transport medium as defined in claim 14, wherein said structure comprises a cyclic organic material regularly arranged on the surface of said microparticle.

18. The heat transport medium as defined in claim 14, wherein the average diameter of said microparticles is 5 nm (nanometer) or less.

19. The heat transport medium as defined in claim 14, wherein said microparticle comprises a metal.

20. The heat transport medium as defined in claim 14, wherein said microparticle comprises an inorganic material.

21. The heat transport medium as defined in claim 14, wherein said microparticle comprises an oxide.

22. The heat transport medium as defined in claim 14, wherein said microparticle comprises an organic material.

23. The heat transport medium as defined in claim 14, wherein said microparticle comprises two or more kinds of substances.

24. The heat transport medium as defined in claim 23, wherein said microparticle comprising two or more kinds of substances has a layered construction and the substance present in the more inner layer has a higher thermal conductivity than that of the substance present in the more outer layer.

25. The heat transport medium as defined in claim 1, wherein said medium contains one or more kinds of freezing-point depressants.

26. The heat transport medium as defined in claim 25, wherein said freezing-point depressant is a solid freezing-point depressant.

27. The heat transport medium as defined in claim 25, wherein said freezing-point depressant is a liquid freezing-point depressant.

28. The heat transport medium as defined in claim 25, wherein said medium contains at least either one of a rust inhibitor and an antioxidant as an additive.

29. The heat transport medium as defined in claim 14, wherein said medium contains one or more kinds of freezing-point depressants.
